(19) United States
(12) Patent Application Publication
(10) Pub. No.: US 2019/0036237 A1
(43) Pub. Date: Jan. 31, 2019

(54) ELECTRIC WIRE WITH TERMINAL

(71) Applicant: YAZAKI CORPORATION, Tokyo (JP)

(72) Inventors: Seiko Maehori, Shizuoka (JP); Hirohito Nakata, Shizuoka (JP)

(21) Appl. No.: 16/046,848

(22) Filed: Jul. 26, 2018

(30) Foreign Application Priority Data
Jul. 27, 2017 (JP) 2017-145540

(51) Int. Cl. H01R 4/62; H01R 4/18

(52) U.S. Cl. CPC H01R 4/62; H01R 4/183

(57) ABSTRACT

An electric wire with a terminal includes an electric wire including a core wire made of aluminum or an aluminum alloy and a terminal fitting electrically connected with the core wire. The terminal fitting includes a barrel part crimp-connected with the core wire to cover an outer circumferential surface of the core wire and to be separated from an outside, and a contact part connected with a counterpart terminal. The terminal fitting is connected with the core wire so that a tip end part of the core wire is exposed from the barrel part and extends to an area between the barrel part and the contact part.

### CROSS REFERENCE TO RELATED APPLICATIONS

This application claims priority from Japanese Patent Application No. 2017-145540 filed on Jul. 27, 2017, the entire contents of which are incorporated herein by reference.

### BACKGROUND OF THE INVENTION

### Field of the Invention

The present invention relates to an electric wire with a terminal which includes an electric wire and a terminal fitting.

### Description of Related Art

For example, in a wire harness routed in a vehicle, an electric wire with a terminal in which a terminal fitting made of copper or a copper alloy is crimp-connected with the electric wire (hereinafter, referred to as an “aluminum electric wire”.) including a core wire made of aluminum or an aluminum alloy is used for reduction in weight. Incidentally, in the electric wire with a terminal, there is a concern that water adhering between the core wire of the electric wire and the terminal fitting which are dissimilar metals becomes an electrolyte so that galvanic corrosion (dissimilar-metal contact corrosion) occurs. Incidentally, as is well known, the galvanic corrosion occurs due to the difference of the standard electrode potential between the dissimilar metals, and as the difference is larger, the galvanic corrosion occurs more easily.

For this reason, a plated layer or an insulation film is formed on a surface of the crimp portion of the terminal fitting to the electric wire, so as to prevent the galvanic corrosion (see, for example, the patent document 1: JP-A-2012-94340, the patent document 2: JP-B-5196535, the patent document 3: JP-A-2012-69449, the patent document 4: JP-A-2013-149598, the patent document 5: JP-A-2013-127907, the patent document 6: JP-A-2013-218866, and the patent document 7: JP-A-2013-182861).

### [Patent Document 1] JP-A-2012-94340

### [Patent Document 2] JP-B-5196535

### [Patent Document 3] JP-A-2012-69449

[Patent Document 4] JP-A-2013-149598

### [Patent Document 5] JP-A-2013-127907

### [Patent Document 6] JP-A-2013-218866

### [Patent Document 7] JP-A-2013-182861

According to a related art, in an electric wire with a terminal, there is a possibility that corrosion of a core wire cannot be prevented completely, and water is infiltrated from between a terminal fitting and the core wire into the core wire so as to cause the corrosion of the core wire. In this regard, further improvement of corrosion resistance is desired.

### SUMMARY

One or more embodiments provide an electric wire with a terminal which is excellent in corrosion resistance by preventing corrosion of a core wire of an aluminum electric wire.

In order to achieve the object described above, an electric wire with a terminal according to the invention is characterized by (1) to (5) below.

In an aspect (1), one or more embodiments provide an electric wire with a terminal including an electric wire including a core wire made of aluminum or an aluminum alloy and a terminal fitting electrically connected with the core wire. The terminal fitting includes a barrel part crimp-connected with the core wire to cover an outer circumferential surface of the core wire and to be separated from an outside, and a contact part connected with a counterpart terminal. The terminal fitting is connected with the core wire so that a tip end part of the core wire is exposed from the barrel part and extends to an area between the barrel part and the contact part.

In an aspect (2), the barrel part includes a first layer containing tin and a second layer containing copper or a copper alloy in this lamination order from a side closer to the core wire. The first layer is formed so that a distance between a surface of the first layer on a core wire side and a surface of the second layer on the core wire side in a laminating direction is larger than a thickness of a copper-tin alloy area formed by the tin contained in the first layer and the copper contained in the second layer in the laminating direction.

In an aspect (3), the contact part includes a third layer containing tin and the second layer in this lamination order from a side closer to the counterpart terminal. The third layer is formed so that a distance between a surface of the third layer on a counterpart terminal side and a surface of the second layer on the counterpart terminal side in the laminating direction is smaller than the distance between the surface of the first layer on the core wire side and the surface of the second layer on the core wire side in the laminating direction.

In an aspect (4), the electric wire with the terminal further includes a connection part which connects the barrel part and the contact part. The connection part includes the first layer and the second layer similarly to the lamination order of the barrel part.

In an aspect (5), the barrel part includes at least one of one or plural recess parts and one or plural convex parts on a surface crimp-connected with the core wire. The tip end part of the core wire is exposed from the barrel part so that the recess part or the convex part which is positioned to be separated most from the tip end part contacts with the core wire when the core wire is corroded through a predetermined corrosion test.

According to the aspect (1), the tip end part of the core wire of the aluminum electric wire is exposed from the barrel part to extend to the area between the barrel part and the contact part. For this reason, even when the core wire is corroded due to the above-described galvanic corrosion, the tip end part exposed from the barrel part is corroded more preferentially than the portion covered with the barrel part. At that time, the corrosion progresses gradually from the tip end part of the core wire. Thus, the corrosion of the portion covered with the barrel part is delayed by the amount of the core wire exposed from the barrel part. In other words, the core wire exposed from the barrel part is corroded sacrificially, so that the contact place (the core wire inside the barrel part), which is important in functioning as the electric wire with a terminal, between the barrel part and the core wire can be prevented from being corroded. Incidentally, the improvement of the corrosion resistance of the electric wire with a terminal can contribute to the miniaturization of the terminal and the thinning of the core wire. As described above, the electric wire with a terminal having this configuration is excellent in the corrosion resistance.

According to the aspect (2), the barrel part crimp-connected with the core wire of the aluminum electric wire includes the first layer containing tin and the second layer containing copper or a copper alloy in an order closer to the core wire. Further, as for the layer structure in the laminating direction, the first layer is formed such that the distance between the surface of the first layer on the core wire side and the surface of the second layer on the core wire side in the laminating direction is larger than the thickness of the copper-tin alloy area, which is produced by the tin contained in the first layer and the copper contained in the second layer, in the laminating direction. For this reason, the copper-tin alloy is not exposed to the surface of the first layer, and the galvanic corrosion between the copper-tin alloy and the core wire of the aluminum electric wire can be prevented.

According to the aspect (3), the contact part connected with the counterpart terminal includes the third layer containing tin. However, the third layer is formed such that the distance between the surface of the third layer on the counterpart terminal side and the surface of the second layer on the counterpart terminal side in the laminating direction is smaller than the distance of the first layer. In other words, the thickness of the third layer in the laminating direction is smaller than the thickness of the first layer in the laminating direction. The reason is that when the thickness of the plated layer provided in the contact part is excessively large, a contact pressure between the counterpart terminal and the contact part may be enlarged so that both terminals are hardly connected. Accordingly, the electric wire with a terminal having this configuration can achieve both a connectivity between the terminal fitting (connection part) and the counterpart terminal and the prevention of the corrosion of the aluminum electric wire in the terminal fitting (barrel part) as described above.

According to the aspect (4), in the connection part which connects the barrel part and the contact part, the first layer and the second layer are provided similarly to the barrel part. Therefore, as described above, even in a case where the terminal fitting is attached such that the tip end part of the core wire of the aluminum electric wire is exposed from the barrel part to extend to the connection part, the corrosion of the core wire exposed from the barrel part can be prevented by preventing the exposure of the copper-tin alloy similarly to the above.

According to the aspect (5), even in a case where the core wire is gradually corroded through the generally-conducted corrosion test of the electric wire with a terminal, the electrical connection between the terminal fitting and the core wire can be maintained since at least a recess part or a convex part which is positioned to be separated most from the tip end part contacts with the core wire. Incidentally, a thermal shock test described in JP-A-2005-174896, JP-A-2005-327690, and JP-A-2013-080682, and Accelerated Environmental Exposure Test of U.S. standard USCAR-21 determined by SAE International are exemplified as the generally-conducted corrosion test of the electric wire with a terminal.

According to one or more embodiments, the electric wire with a terminal can be provided which is excellent in the corrosion resistance by preventing the corrosion of the core wire of the aluminum electric wire.

By reading through the following described a mode to carry out the invention (hereinafter, referred to as an “embodiment”) with reference to the accompanying drawings, details of the invention will be further clarified.

### BRIEF DESCRIPTION OF THE DRAWINGS

FIG. 1 is a perspective view of an electric wire with a terminal.

FIG. 2 is a sectional view of the electric wire with a terminal taken along line A-A of FIG. 1.

FIG. 3 is a sectional view of the electric wire with a terminal taken along line B-B of FIG. 2.

FIG. 4 is a plan view of a chain-like terminal fitting after a punch processing.

FIG. 5 is a plan view of the chain-like terminal fitting after a plating treatment.

FIG. 6A is a sectional view of the terminal fitting taken along line C-C of FIG. 5. FIG. 6B is a sectional view of the terminal fitting taken along line D-D of FIG. 5.

FIG. 7 is a sectional view corresponding to FIG. 3 in a case where the core wire of the electric wire is corroded through a predetermined corrosion test.

### DETAILED DESCRIPTION

Hereinafter, an embodiment according to the invention will be described with reference to the drawing.

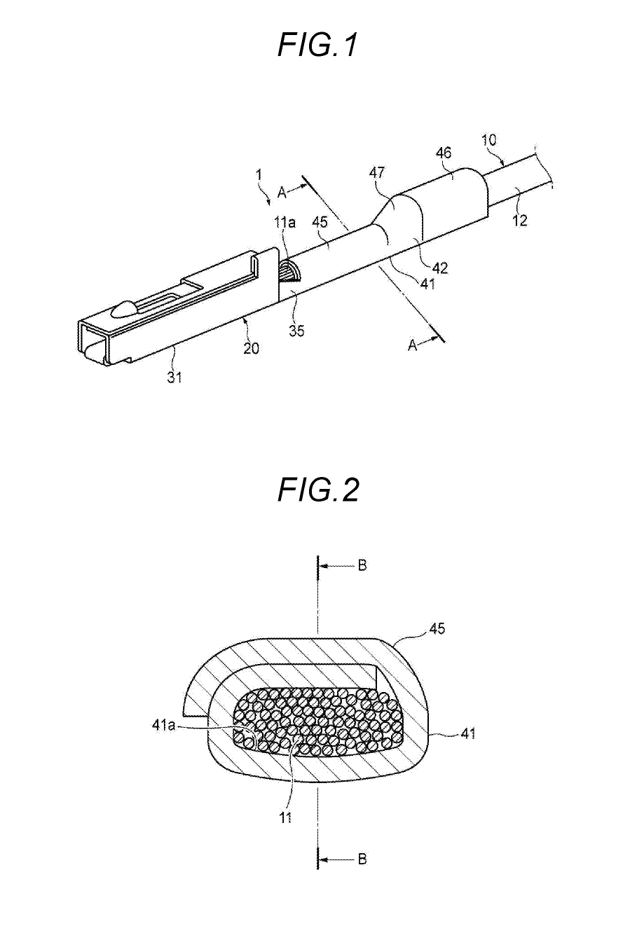

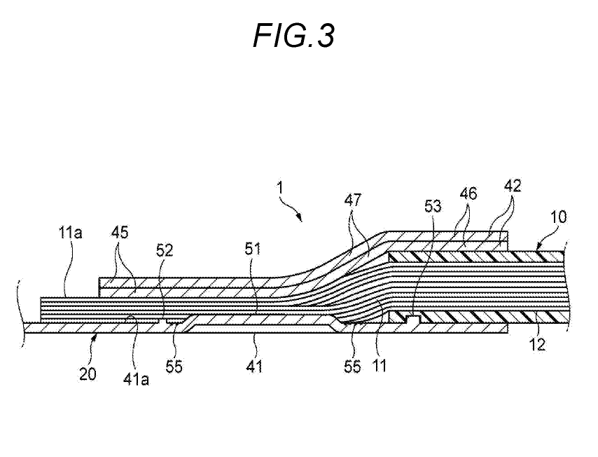

FIG. 1 is a perspective view of an electric wire with a terminal 1 according to this embodiment. FIG. 2 is a sectional view taken along line A-A of FIG. 1. FIG. 3 is a sectional view taken along line B-B of FIG. 2.

As illustrated in FIGS. 1 to 3, a terminal fitting 20 is crimped to an end part of an electric wire 10, and the terminal fitting 20 is electrically connected with a core wire 11 of the electric wire 10. The electric wire with a terminal 1 includes the electric wire 10 and the terminal fitting 20. The electric wire with a terminal 1 forms a wire harness routed in the vehicle such as an automobile.

The electric wire 10 is an insulation electric wire including the core wire 11 and a coating 12 which covers the core wire 11 and is made of a resin. The core wire 11 is made of aluminum or an aluminum alloy, and is formed by twisting a plurality of strands. When the core wire 11 of the electric wire 10 is made of aluminum or an aluminum alloy, the terminal fitting 20 is reduced in weight, and the wire harness including the terminal fitting 20 is also reduced in weight. The terminal fitting 20 reduced in weight is properly used particularly in a vehicle, which uses frequently the wire harness, such as an electric automobile or a hybrid automobile.

The terminal fitting 20 includes a contact part 31 to be connected with a counterpart terminal on a front side, and a barrel part 41 to be connected with the core wire 11 of the electric wire 10 on a rear side. The contact part 31 and the barrel part 41 are connected with each other by a connection part 35.

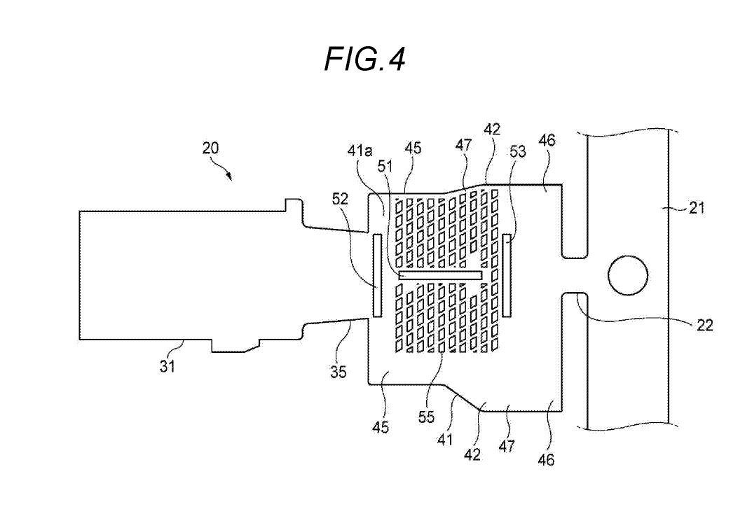

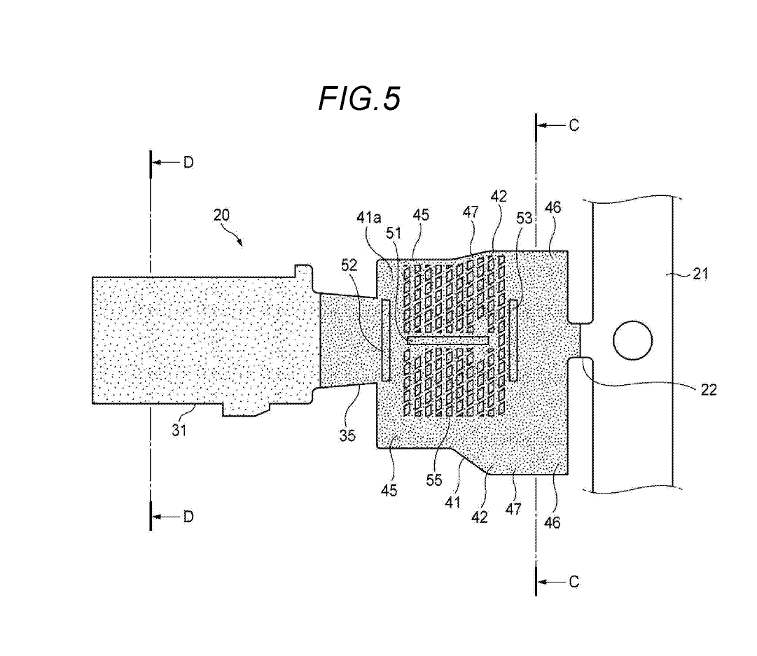

FIG. 4 is a plan view of a chain-like terminal fitting after a punch processing. FIG. 5 is a plan view of the chain-like terminal fitting after a plating treatment. As illustrated in FIG. 4, the terminal fitting 20 is formed by performing a press processing (a punch processing and a bend processing) on a metal plate. The terminal fitting 20 is formed of a metal material which is different from the core wire 11 of the electric wire 10 made of aluminum or an aluminum alloy. Specifically, the terminal fitting 20 is formed by using the metal plate made of copper or a copper alloy as a base material. The terminal fitting 20 is connected with a belt-shaped carrier 21 and is punched to be continuous in a chain shape. Further, when crimp-fixed to the electric wire 10, the terminal fitting 20 is cut at a connection place 22 with the carrier 21 to be separated from the carrier 21.

After punched by the press processing, as illustrated in FIG. 5, the terminal fitting 20 is subjected to the plating treatment before crimped to the electric wire 10, so that corrosion (to be described later) of the core wire 11 of the electric wire 10 is prevented to improve corrosion resistance. In this embodiment, the terminal fitting 20 is subjected to the plating treatment by tin (Sn) before crimped to the electric wire 10. Specifically, a plated layer (hereinafter, referred to as “tin-plated layer”.) containing tin is provided in a terminal fitting 20, so as to cover front and rear surfaces and a side surface which is constituted by a cutting surface formed by the press processing.

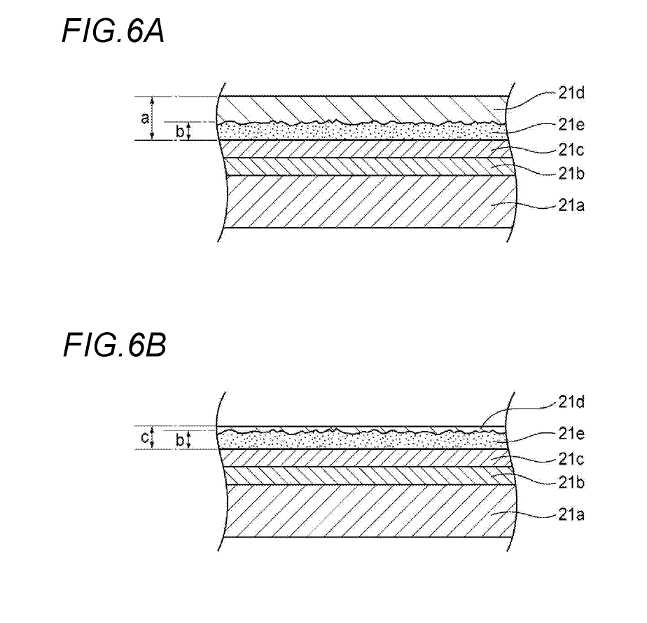

As illustrated in FIG. 6A, a base material layer 21a of the terminal fitting 20, a nickel layer 21b, a foundation layer 21c of the copper, and a tin-plated layer 21d are laminated in this order in the barrel part 41. In other words, the base material layer 21a is subjected to a surface treatment in which the nickel layer 21b, the foundation layer 21c of the copper, and the tin-plated layer 21d are laminated in this order. Conversely, the barrel part 41 includes the tin-plated layer 21d and the foundation layer 21c of the copper in this lamination order from a side closer to the core wire 11 when crimp-connected with the core wire 11 of the electric wire 10. At that time, a copper-tin alloy area 21e made of tin and copper is formed between the foundation layer 21c and the tin-plated layer 21d to be grown from the foundation layer 21c toward the inside of the tin-plated layer 21d.

The barrel part 41 is subjected to the above-described surface treatment, and as illustrated in FIGS. 6A and 6B, the thickness of the tin-plated layer 21d is designed in advance such that a distance a in the laminating direction between the surface of the tin-plated layer 21d on the core wire 11 side and the surface of the foundation layer 21c on the core wire 11 side is larger than the thickness b in a laminating direction (a vertical direction in FIGS. 6A and 6B) of the copper-tin alloy area 21e (a>b). The design may be made in consideration of the growth degree of the copper-tin alloy area 21e specified based on a preliminary experiment and the like. Further, the design may be made in consideration of the scraping (the reduction amount of the thickness of the tin-plated layer 21d), which occurs when the barrel part 41 is caulked by the core wire 11, of the tin-plated layer 21d in addition to the growth degree of the copper-tin alloy area 21e. For example, in a case where both of them are considered, the thickness of the tin-plated layer 21d may be 3 μm or more.

When the tin-plated layer 21d has such a thickness, it is prevented that the copper-tin alloy area 21e is exposed to the surface of the tin-plated layer 21d. Herein, the standard electrode potential of the copper-tin alloy is different according to the composition, but generally is larger than the standard electrode potential of the tin (original tin-plated layer 21d). That is, the difference (the copper-tin alloy area 21e is exposed) of the standard electrode potential between the copper-tin alloy and the aluminum material of the core wire 11 is larger than the difference (the copper-tin alloy area 21e is not exposed) of the standard electrode potential between the tin and the aluminum material of the core wire 11. Accordingly, as compared to a case where there is an exposure, the galvanic corrosion between the core wire 11 of the electric wire 10 and the copper-tin alloy area 21e is prevented by preventing the exposure of the copper-tin alloy area 21e.

On the other hand, as illustrated in FIG. 6B, the contact part 31 is also subjected to the surface treatment similarly to the barrel part 41. However, in the surface treatment performed on the contact part 31, a distance c in the laminating direction between the surface of the tin-plated layer 21d on the counterpart terminal side and the surface of the foundation layer 21c on the counterpart terminal side is smaller than the same distance a in the barrel part 41. In other words, the thickness of the tin-plated layer 21d of the contact part 31 in the laminating direction is smaller than the thickness of the tin-plated layer 21d of the barrel part 41 in the laminating direction. The reason is that when the thickness of the tin-plated layer 21d provided in the contact part 31 is excessively large, a contact pressure applied when the counterpart terminal and the contact part 31 are connected (formed in a cylindrical shape as illustrated in FIG. 1) may be enlarged so that the counterpart terminal and the terminal fitting 20 are hardly connected. Incidentally, the thickness of the tin-plated layer 21d provided in the contact part 31 can be specified based on a preliminary experiment or the like, and may be about 1 μm, for example.

As described above, in the terminal fitting 20 of this embodiment, the surface treatment performed on the barrel part 41 and the surface treatment performed on the contact part 31 are different from each other in terms of the thickness of the tin-plated layer 21d in the laminating direction.

The connection part 35 is also subjected to the surface treatment similarly to the barrel part 41, and the connection part 35 has a sectional structure similar to FIG. 6A. Therefore, as described below, in a case where the terminal fitting 20 is attached such that a tip end part 11a of the core wire 11 of the electric wire 10 is exposed from the barrel part 41 to extend to the connection part 35, the corrosion of the core wire 11 exposed from the barrel part 41 can be prevented by preventing the exposure of the copper-tin alloy similarly to the above.

After the surface treatment is performed as described above, the contact part 31 is formed in a cylindrical shape having an open tip end part as illustrated in FIG. 1. The counterpart terminal is inserted into the opening portion of the contact part 31, and the contact part 31 and the counterpart terminal are connected electrically.

The barrel part 41 is crimped to the end part of the electric wire 10 to be connected electrically. The barrel part 41 includes a pair of crimp pieces 42. In each of the crimp pieces 42, the front side serves as a conductor crimp part 45, and the rear side serves as a covered crimp part 46. In addition, in the crimp piece 42, a portion between the conductor crimp part 45 and the covered crimp part 46 serves as a connecting part 47. In the barrel part 41, an upper surface as one surface serves as a placing surface 41a on which the end part of the electric wire 10 is arranged. The crimp piece 42 is bent to enclose the end part of the electric wire 10 in a state where the end part of the electric wire 10 is arranged on the placing surface 41a. Therefore, in the crimp pieces 42, the respective end parts are caulked to be overlapped with each other and are crimped to the end part of the electric wire 10.

When the barrel part 41 is crimped to the end part of the electric wire 10, as illustrated in FIG. 3, the barrel part 41 is crimp-connected with the core wire 11 to cover the outer circumferential surface of the core wire 11 and to be separated from the outer portion. Further, at that time, the tip end part 11a of the core wire 11 is exposed from the barrel part 41 to extend to the area (connection part 35) between the barrel part 41 and the contact part 31.

The following method is exemplified as a method that allows the tip end part 11a of the core wire 11 to be exposed from the barrel part 41. For example, a method is exemplified in which the tip end part 11a of the core wire 11 is arranged in the area between the barrel part 41 and the contact part 31 before the barrel part 41 is crimped to the core wire 11, and then the barrel part 41 is crimped to the core wire 11. Further, for example, a method is exemplified in which the tip end part of the core wire 11 is positioned to be covered with the barrel part 41 before the barrel part 41 is crimped to the core wire 11, and in the process of crimping the barrel part 41 to the core wire 11, the core wire 11 is deformed to be exposed from the barrel part 41 (extrudes from the barrel part 41). Among these methods, in the latter method, the core wire 11 and the barrel part 41 slide in a close contact state when the core wire 11 extrudes from the barrel part 41. Thus, there is a merit that the electrical connection between the core wire 11 and the barrel part 41 can be made more firmly.

A pressure protrusion part 51 (protrusion part), a front protrusion part 52 (protrusion part), and a rear protrusion part 53 (protrusion part) are formed in the barrel part 41. The pressure protrusion part 51 is provided substantially in the center of the barrel part 41 in a width direction, and is formed along a longitudinal direction of the electric wire 10. The front protrusion part 52 is provided on the front side of the barrel part 41, and the rear protrusion part 53 is provided on the rear side of the barrel part 41. Both the front protrusion part 52 and the rear protrusion part 53 are formed along the width direction of the barrel part 41. All of the pressure protrusion part 51, the front protrusion part 52, and the rear protrusion part 53 protrude to the inside which is the electric wire 10 side from the placing surface 41a on which the end part of the electric wire 10 is placed. Further, in the barrel part 41, a serration 55 including a plurality of hole parts is formed in the inner surface which is the placing surface 41a.

When the crimp piece 42 of the barrel part 41 is crimped to the end part of the electric wire 10, as illustrated in FIG. 3, the pressure protrusion part 51 presses against the core wire 11 of the electric wire 10 along the longitudinal direction of the electric wire 10, so that the crimp strength of the core wire 11 by the conductor crimp part 45 of the crimp piece 42 is improved along the longitudinal direction. Further, in the portion near the tip of the core wire 11 of the electric wire 10, the crimp piece 42 is caulked such that the front protrusion part 52 bites into the core wire 11 in a circumferential direction, and thus the crimp strength is improved in the vicinity of the tip of the core wire 11. Therefore, it is suppressed that the water is infiltrated from the front side of the barrel part 41 into the core wire 11. In addition, in the portion of the coating 12 of the electric wire 10, the rear protrusion part 53 bites into the coating 12 in the circumferential direction, and thus the crimp strength in the coating 12 is improved. Therefore, it is suppressed that the water is infiltrated from the rear side of the barrel part 41 into a gap between the covered crimp part 46 and the coating 12.

When the crimp piece 42 is crimped to the electric wire 10, the serration 55 formed in the placing surface 41a of the barrel part 41 bites into the core wire 11. Therefore, an oxide film of the surface of the core wire 11 is removed to obtain an excellent conductive state between the electric wire 10 and the terminal fitting 20.

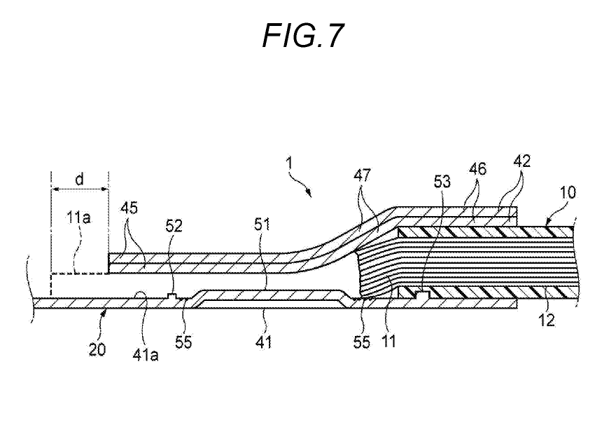

Herein, as illustrated in FIG. 7, preferably, an exposure amount d (exposure length) of the tip end part 11a of the core wire 11 exposed from the barrel part 41 as described above is determined to be at least such exposure amount that the serration 55 which is positioned to be separated most from the tip end part 11a contacts with the core wire 11 when the core wire 11 is corroded gradually through a generally-conducted corrosion test of the electric wire with a terminal 1. Incidentally, as described above, a thermal shock test described in JP-A-2005-174896 and the like, a test complying with U.S. standard USCAR-21, and the like are exemplified as an example of the generally-conducted corrosion test. Typically, these corrosion tests evaluate the performance of the electric wire with a terminal based on a change degree of an electric resistance value of the terminal crimp part (in this embodiment, the conductor crimp part 45) before and after the tests. On the other hand, in this embodiment, when the exposure amount d of the tip end part 11a of the core wire 11 is determined, the test environment prescribed in these corrosion tests is used to focus on the degree of the remaining core wire 11 after the core wire 11 is corroded through the test. If the exposure amount d is determined to be the above-described exposure amount, it is considered that the electrical connection can be maintained between the terminal fitting 20 and the core wire 11 as long as the electric wire with a terminal 1 is used under the generally-assumed use environment.

As described above, in the electric wire with a terminal 1 according to this embodiment, the tip end part 11a of the core wire 11 of the electric wire 10 is exposed from the barrel part 41 to extend to the area between the barrel part 41 and the contact part 31. For this reason, when the core wire 11 is corroded by the above-described galvanic corrosion, the tip end part 11a exposed from the barrel part 41 is corroded more preferentially than the portion covered with the barrel part 41. Further, the corrosion progresses gradually from the tip end part 11a of the core wire 11. Thus, the corrosion of the portion covered with the barrel part 41 is delayed by the length of the core wire 11 exposed from the barrel part 41. In other words, the core wire 11 exposed from the barrel part 41 is corroded sacrificially, so that it can be suppressed that the contact place (the core wire 11 inside the barrel part 41), which is important in functioning as the electric wire with a terminal 1, between the barrel part 41 and the core wire 11 is corroded. Therefore, the electric wire with a terminal 1 is excellent in the corrosion resistance.

In addition, in the electric wire with a terminal 1, the barrel part 41 crimp-connected with the core wire 11 of the electric wire 10 includes the tin-plated layer 21d and the foundation layer 21c of the copper in an order closer to the core wire 11. Further, as for the layer structure in the laminating direction, the tin-plated layer 21d is formed such that the distance between the surface of the tin-plated layer 21d on the core wire 11 side and the surface of the foundation layer 21c on the core wire 11 side in the laminating direction is larger than the thickness of the copper-tin alloy area 21e, which is produced by the tin contained in the tin-plated layer 21d and the copper contained in the foundation layer 21c, in the laminating direction. For this reason, the copper-tin alloy is not exposed to the surface of the tin-plated layer 21d, and the galvanic corrosion between the copper-tin alloy and the core wire 11 can be prevented.

The contact part 31 connected with the counterpart terminal includes the tin-plated layer 21d of which the thickness in the laminating direction is smaller than that of the tin-plated layer 21d of the barrel part 41. Therefore, it can be prevented that the contact pressure between the counterpart terminal and the contact part 31 of the terminal fitting 20 is excessively high, and the counterpart terminal is hardly connected with the terminal fitting 20.

The tin-plated layer 21d similar to the barrel part 41 is provided in the connection part 35 which connects the barrel part 41 and the contact part 31. Therefore, even in a case where the terminal fitting 20 is attached such that the tip end part 11a of the core wire 11 is exposed from the barrel part 41 to extend to the connection part 35, the galvanic corrosion of the core wire 11 can be prevented similarly to the above.

Even in a case where the core wire 11 is gradually corroded through the generally-conducted corrosion test of the electric wire with a terminal 1, the electrical connection between the terminal fitting 20 and the core wire 11 can be maintained since at least the serration 55 which is positioned to be separated most from the tip end part 11a contacts with the core wire 11.

Incidentally, the invention is not limited to the above-described embodiment, and various modifications may be adopted within the scope of the invention. For example, the invention is not limited to the above-described embodiment, and may be modified or improved appropriately. In addition, materials, shapes, sizes, the number, arrangement place, or the like of each component in the above-described embodiments are arbitrary and not limited as long as they can attain the invention.

For example, various protrusion parts (the pressure protrusion part 51, the front protrusion part 52, and the rear protrusion part 53) are formed in the barrel part 41 in the above-described embodiment. However, the terminal fitting according to the invention may not include such a protrusion part. The same applies to the serration 55.

In the barrel part 41 in the above-described embodiment, the nickel layer 21b and the foundation layer 21c are held between the base material layer 21a and the tin-plated layer 21d. However, the tin-plated layer 21d may be directly provided on the base material layer 21a.

Herein, the features of the embodiments of the electric wire with a terminal according to the invention will be simply summarized as the following [1] to [5].

[1] An electric wire with a terminal (1) comprising:

an electric wire (10) including a core wire (11) made of aluminum or an aluminum alloy; and

a terminal fitting (20) connected with a terminal part of the electric wire,

wherein the terminal fitting (20) includes a barrel part (41) crimp-connected with the core wire to cover an outer circumferential surface of the core wire (11) and to be separated from an outside, and a contact part (31) connected with a counterpart terminal, and

wherein the terminal fitting is connected with the electric wire (10) so that a tip end part (11a) of the core wire is exposed from the barrel part (41) and extends to an area between the barrel part (41) and the contact part (31).

[2] The electric wire with the terminal according to [1],

wherein the barrel part (41) includes a first layer (21d) containing tin and a second layer (21c) containing copper or a copper alloy in this lamination order from a side closer to the core wire, and

wherein the first layer is formed so that a distance (a) between a surface of the first layer on the core wire side and a surface of the second layer on the core wire side in a laminating direction is larger than a thickness (b) of a copper-tin alloy area (21e) formed by the tin contained in the first layer and the copper contained in the second layer in the laminating direction.

[3] The electric wire with the terminal according to [2],

wherein the contact part (31) includes a third layer (21d) containing tin and the second layer in this lamination order from a side closer to the counterpart terminal, and

the third layer is formed such that a distance (c) between a surface of the third layer on the counterpart terminal side and a surface of the second layer on the counterpart terminal side in the laminating direction is smaller than the distance (a) between the surface of the first layer on the core wire side and the surface of the second layer on the core wire side in the laminating direction.

[4] The electric wire with the terminal according to [2] or [3], further comprising:

a connection part (35) which connects the barrel part and the contact part,

wherein the connection part includes the first layer and the second layer similarly to the lamination order of the barrel part.

[5] The electric wire with the terminal according to any one of [1] to [4],

wherein the barrel part (41) includes at least one of one or plural recess parts and one or plural convex parts (55) on a surface crimp-connected with the core wire, and

wherein the tip end part (11a) of the core wire is exposed from the barrel part so that the recess part or the convex part (55) which is positioned to be separated most from the tip end part contacts with the core wire (11) when the core wire is corroded through a predetermined corrosion test.

### DESCRIPTION OF REFERENCE NUMERALS AND SIGNS

1: electric wire with terminal

10: electric wire

11: core wire

11a: tip end part of core wire

20: terminal fitting

21a: base material layer

21b: nickel layer

21c: foundation layer (second layer)

21d: tin-plated layer (first layer, third layer)

21e: copper-tin alloy area

31: contact part

35: connection part

41: barrel part

What is claimed is:

1. An electric wire with a terminal comprising:
an electric wire including a core wire made of aluminum or an aluminum alloy; and
a terminal fitting electrically connected with the core wire,
wherein the terminal fitting includes a barrel part crimp-connected with the core wire to cover an outer circumferential surface of the core wire and to be separated from an outside, and a contact part connected with a counterpart terminal, and
wherein the terminal fitting is connected with the core wire so that a tip end part of the core wire is exposed from the barrel part and extends to an area between the barrel part and the contact part.

2. The electric wire with the terminal according to claim 1,
wherein the barrel part includes a first layer containing tin and a second layer containing copper or a copper alloy in this lamination order from a side closer to the core wire, and
wherein the first layer is formed so that a distance between a surface of the first layer on a core wire side and a surface of the second layer on the core wire side in a laminating direction is larger than a thickness of a copper-tin alloy area formed by the tin contained in the first layer and the copper contained in the second layer in the laminating direction.

3. The electric wire with the terminal according to claim 2,
wherein the contact part includes a third layer containing tin and the second layer in this lamination order from a side closer to the counterpart terminal, and
wherein the third layer is formed so that a distance between a surface of the third layer on a counterpart terminal side and a surface of the second layer on the counterpart terminal side in the laminating direction is smaller than the distance between the surface of the first layer on the core wire side and the surface of the second layer on the core wire side in the laminating direction.

4. The electric wire with the terminal according to claim 2, further comprising:
a connection part which connects the barrel part and the contact part,
wherein the connection part includes the first layer and the second layer similarly to the lamination order of the barrel part.

5. The electric wire with the terminal according to claim 1,
wherein the barrel part includes at least one of one or plural recess parts and one or plural convex parts on a surface crimp-connected with the core wire, and
wherein the tip end part of the core wire is exposed from the barrel part so that the recess part or the convex part which is positioned to be separated most from the tip end part contacts with the core wire when the core wire is corroded through a predetermined corrosion test.
